(19) United States
(12) Patent Application Publication
(10) Pub. No.: US 2009/0031209 A1
(43) Pub. Date: Jan. 29, 2009

(54) Apparatus and method for adding product or service offers from one website to another website

(75) Inventor: Neal D. Rapoport, Plano, TX (US)

Correspondence Address: DOCKET CLERK, P.O. DRAWER 800889, DALLAS, TX, 75380, US

(73) Assignee: NARAE ENTERPRISES, INC., Plano, TX (US)

(21) Appl. No.: 11/880,710

(22) Filed: Jul. 24, 2007

(51) Int. Cl. G06F 15/00

(52) U.S. Cl. 715/229

(57) ABSTRACT

Product or service offers from one website can be quickly and easily added to another website. For example, a web page containing information associated with one or more offers for one or more items can be generated and provided to a user. The information could represent pricing information or discounts associated with the one or more items. The user can select one of the offers, such as by selecting pricing information or a discount associated with one of the items. A formatted forum post or a gift registry entry could be generated, where at least part of the contents of the forum post or gift registry entry is automatically selected or generated based on the selected offer. A thread in a forum can be created using the forum post, or the gift registry entry can be added to at least one gift registry.

### TECHNICAL FIELD

This disclosure is generally directed to computing systems and more specifically to an apparatus and method for adding product or service offers from one website to another website.

### BACKGROUND

Many different businesses and other entities operate or support websites, such as websites that present product or service-related information to customers and that accept orders for products or services from customers. Many businesses and other entities (on their own or through affiliated parties) also provide coupons, discounts, or other specific offers for the products and services they provide.

Tracking websites routinely track or compile coupons and pricing information related to various businesses and other entities. Product and service-related pricing information and coupon codes are then made available to members of those tracking websites. For example, a member of a tracking website could access the tracking website and search for coupons related to a particular product or service, a particular vendor, or a particular product manufacturer or service provider. The tracking website could then display any available coupons to the member. As another example, a member of a tracking website could access the tracking website and provide search criteria, such as the name or type of a product or service. The tracking website could then display prices for any product or service that matches the search criteria.

### SUMMARY

This disclosure provides an apparatus and method for adding product or service offers from one website to another website.

In a first embodiment, a method includes generating a web page that includes information associated with one or more offers for one or more items. The method also includes providing the web page for presentation to a first user and receiving a selection of one of the offers. The method further includes generating a forum post, where at least a portion of the contents of the forum post is automatically selected or generated based on the selected offer. In addition, the method includes creating a thread in a forum using the forum post, where the thread is accessible by one or more second users.

In particular embodiments, the method also includes generating a second web page that includes the forum post and providing the second web page for presentation to the one or more second users.

In other particular embodiments, the web page includes pricing information associated with the one or more items. Also, receiving the selection of one of the offers includes receiving a selection associated with the pricing information for one of the items.

In yet other particular embodiments, the web page includes discounts associated with the one or more items. Also, receiving the selection of one of the offers includes receiving a selection associated with the discount for one of the items.

In still other particular embodiments, the method also includes presenting the forum post to the first user and allowing the first user to modify the forum post prior to creating the thread in the forum.

In additional particular embodiments, generating the forum post includes generating a forum post having an image, a description, and a hyperlink associated with one of the items.

In a second embodiment, an apparatus includes at least one memory configured to store information associated with one or more offers for one or more items. The apparatus also includes at least one processor configured to generate a web page including at least some of the information associated with the one or more offers. The at least one processor is also configured to provide the web page for presentation to a first user and to receive a selection of one of the offers. The at least one processor is further configured to generate a forum post, where at least a portion of the contents of the forum post is automatically selected or generated based on the selected offer. In addition, the at least one processor is configured to create a thread in a forum using the forum post, where the thread accessible by one or more second users.

In a third embodiment, a computer program is embodied on a computer readable medium. The computer program includes computer readable program code for generating a web page that includes information associated with one or more offers for one or more items. The computer program also includes computer readable program code for providing the web page for presentation to a first user and for receiving a selection of one of the offers. The computer program further includes computer readable program code for generating a forum post, where at least a portion of the contents of the forum post is automatically selected or generated based on the selected offer. In addition, the computer program includes computer readable program code for creating a thread in a forum using the forum post, where the thread is accessible by one or more second users.

In a fourth embodiment, a method includes generating a web page that includes information associated with one or more offers for one or more items. The method also includes providing the web page for presentation to a first user and receiving a selection of one of the offers. The method further includes generating a gift registry entry, where at least a portion of the contents of the gift registry entry is automatically selected or generated based on the selected offer. In addition, the method includes adding the gift registry entry to at least one gift registry, where the gift registry entry is accessible by one or more second users.

In a fifth embodiment, an apparatus includes at least one memory configured to store information associated with one or more offers for one or more items. The apparatus also includes at least one processor configured to generate a web page that includes at least some of the information associated with the one or more offers. The at least one processor is also configured to provide the web page for presentation to a first user and to receive a selection of one of the offers. The at least one processor is further configured to generate a gift registry entry, where at least a portion of the contents of the gift registry entry is automatically selected or generated based on the selected offer. In addition, the at least one processor is configured to add the gift registry entry to at least one gift registry, where the gift registry entry is accessible by one or more second users.

In a sixth embodiment, a computer program is embodied on a computer readable medium. The computer program includes computer readable program code for generating a web page that includes information associated with one or more offers for one or more items. The computer program also includes computer readable program code for providing the web page for presentation to a first user and for receiving a selection of one of the offer. The computer program further includes computer readable program code for generating a gift registry entry, where at least a portion of contents of the gift registry entry is automatically selected or generated based on the selected offer. In addition, the computer program includes computer readable program code for adding the gift registry entry to at least one gift registry, where the gift registry entry is accessible by one or more second users.

Other technical features may be readily apparent to one skilled in the art from the following figures, descriptions, and claims.

### BRIEF DESCRIPTION OF THE DRAWINGS

For a more complete understanding of this disclosure and its features, reference is now made to the following description, taken in conjunction with the accompanying drawings, in which:

FIG. 1 illustrates an example system for adding product or service offers from one website to another website according to this disclosure;

FIGS. 2 through 5B illustrate example web pages showing the addition of a product or service offer from one website to another website according to this disclosure; and

FIG. 6 illustrates an example method for adding product or service offers from one website to another website according to this disclosure.

### DETAILED DESCRIPTION

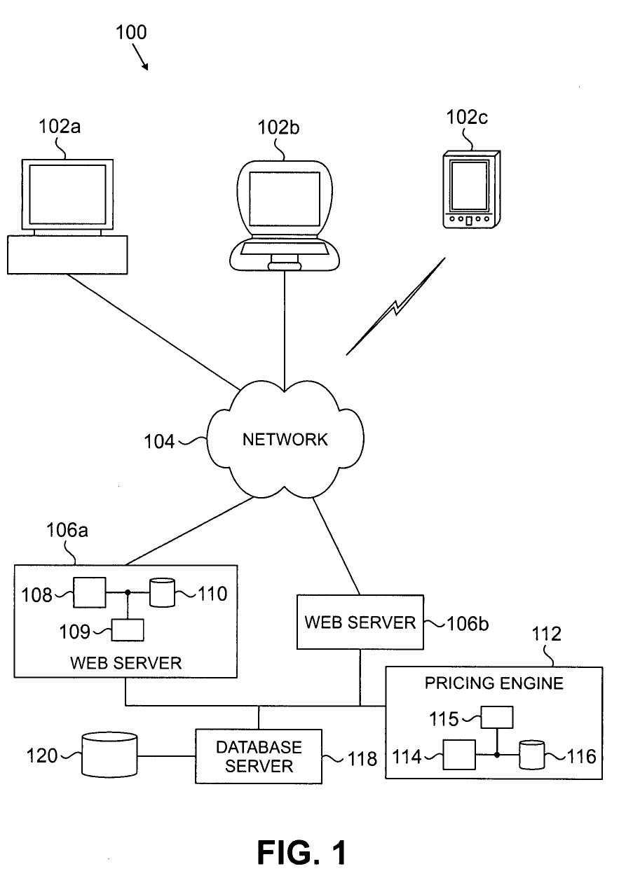

FIGS. 1 through 6, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

FIG. 1 illustrates an example system 100 for adding product or service offers from one website to another website according to this disclosure. The embodiment of the system 100 shown in FIG. 1 is for illustration only. Other embodiments of the system 100 may be used without departing from the scope of this disclosure.

In this example embodiment, the system 100 includes various end user devices 102a-102c. Each of the user devices 102a-102c communicates over a network 104. For example, each of the user devices 102a-102c may receive and display a web page to a user, and the user could use the user device 102a-102c to provide information via the web page (such as by providing information identifying a product or service to be searched). As described in more detail below, at least some of the web pages received by the user devices 102a-102c from one website contain information identifying offers for products or services (such as prices or coupons), and the system 100 supports a mechanism for adding the offers to another website. In this particular example, the user devices 102a-102c include a desktop computer (102a), a laptop computer (102b), and a personal digital assistant (102c). Each of these user devices 102a-102c communicates over a wired or wireless connection. These user devices 102a-102c are for illustration only. Any other or additional computing or communication devices may be used in the system 100. Each of the user devices 102a-102c includes any suitable structure allowing a user to communicate and interact over a network.

The network 104 facilitates communication between various components in the system 100. For example, the network 104 may communicate Internet Protocol (IP) packets, frame relay frames, Asynchronous Transfer Mode (ATM) cells, or other suitable information between network addresses. The network 104 may include one or more local area networks (LANs), metropolitan area networks (MANs), wide area networks (WANs), all or a portion of a global network such as the Internet, or any other communication system or systems at one or more locations. The network 104 may also operate according to any appropriate type of protocol or protocols, such as Ethernet, IP, X.25, frame relay, or any other protocol.

In this example, two web servers 106a-106b are coupled to the network 104. The web servers 106a-106b support communication and interaction with the user devices 102a-102c over the network 104. For example, the web servers 106a-106b may generate web pages and provide the web pages to the user devices 102a-102c over the network 104. As particular examples, the web servers 106a-106b may generate a main web page or home page for a particular offer-tracking entity. The home page could provide users with information associated with offers from various vendors. The home page could also allow the users to enter search criteria for locating particular offers, or the home page could support or provide access to other mechanisms for browsing or locating offers. The web servers 106a-106b could provide additional web pages to the user devices 102a-102c, such as web pages containing coupons, pricing information, or other offer-related information. In this document, the term “offer” and its derivatives refer to any offer to provide a product or service. For example, offers include an offer to sell a product or service at a specified price or an offer to sell a product or service at a discount (such as a price reduced via a coupon, sale, or other deal). As particular examples, offers include an offer contained in price search results (such as a search performed to identify different vendors' prices for a product or service) or an offer for a product or service identified in a gift registry. Also, the term “discount” and its derivatives refer to any reduction in the price or associated charges (such as shipping costs) related to a product or service, such as coupons for a product or service honored by a vendor. Further, the term “vendor” and its derivatives refer to any individual, business, or other entity offering a product or service. In addition, the term “item” and its derivatives are used in this patent document to denote both products and services.

In this particular example, two web servers 106a-106b are shown as being coupled to the network 104. In this embodiment, both web servers 106a-106b could be used to facilitate communications with the user devices 102a-102c. Also, any suitable technique could be used to route individual user devices 102a-102c to specific ones of the web servers 106a-106b, such as by using load-sharing techniques.

The web servers 106a-106b could support additional functionality related to the presentation of offer-related information to users. For example, the web servers 106a-106b could support or provide a forum for users to interact. In these forums, members could identify and discuss offers for products or services, as well as any other information associated with products or services provided by on-line or other vendors. In particular embodiments, the web servers 106a-106b could allow forum members to identify offers for various products and services, and the web servers 106a-106b could then notify other users of those offers (such as by including information identifying those offers in web pages presented to the other users). In general, a forum typically allows users to start new discussions, where each discussion is often referred to as or is associated with a “thread.” Each thread typically includes a collection of “posts,” which represent comments from individual users about a particular topic or other users' comments. As a particular example, each thread in the forum could be associated with a particular offer for a product or service, and the posts could mainly be associated with the offer, the vendor providing the offer, or other users' comments.

The web servers 106a-106b could use any suitable protocol(s) to communicate with the user devices 102a-102c. For example, the web servers 106a-106b could support the use of hypertext markup language (HTML) to communicate web pages to the user devices 102a-102c. The web servers 106a-106b could also support Secure Sockets Layer (SSL) or other techniques to facilitate secure communications with the user devices 102a-102c.

Each of the web servers 106a-106b includes any suitable structure for providing offer-related information to user devices. As a particular example, each of the web servers 106a-106b could include one or more processors 108, one or more network interfaces 109, and one or more memories 110 containing instructions and data used, generated, or collected by the one or more processors 108. The one or more network interfaces 109 facilitate communication over a network, such as an Ethernet interface.

In this example, a pricing engine 112 is coupled to or is otherwise accessible from the web servers 106a-106b. The pricing engine 112 contains logic, such as software routines, that can search for and identify pricing-related information for items offered by various vendors. The pricing engine 112 could, for example, receive information identifying a specific product from one of the web servers 106a-106b, search for any vendor that sells the specific product, and identify a price charged by each of the identified vendors. The pricing engine 112 could also identify additional information associated with a specific product or service or with vendors, such as shipping costs and taxes charged by the vendors and whether each vendor has a specific product in stock. The pricing engine 112 could make this information available to the web servers 106a-106b, which could include this information in web pages provided to the user devices 102a-102c.

The pricing engine 112 includes any suitable structure for identifying prices (and possibly related charges) for products or services and incorporating coupons or other discounts. As a particular example, the pricing engine 112 could include one or more processors 114, one or more network interfaces 115, and one or more memories 116 containing instructions and data used, generated, or collected by the one or more processors 114. The one or more network interfaces 115 facilitate communication over a network, such as an Ethernet interface.

A database server 118 is coupled to the web servers 106a-106b, the pricing engine 112, and a database 120. The database 120 stores various information used, collected, or generated by the web servers 106a-106b and the pricing engine 112. For example, the database 120 could store information identifying offers (such as prices and discounts) for various products or services offered by vendors. The database 120 could also store information identifying shipping costs, tax rates, addresses, payment information, and other information associated with the vendors. The database 120 could further store information associated with an on-line forum accessible through the web servers 106a-106b, such as information associated with the threads and posts in the forum.

The database server 118 provides access to and control over the data stored in the database 120. For example, the database server 118 can support the storage of data in and the retrieval of data from the database 120. The database server 118 may also ensure that components attempting to access the database 120 are authorized.

The database server 118 includes any suitable structure for providing access to a database of information. The database 120 includes any suitable structure for storing and facilitating retrieval of information. The database 120 also uses any of a variety of data structures, arrangements, and compilations to store and facilitate retrieval of information.

In one aspect of operation, different websites can be accessed by the user devices 102a-102c. For example, the user devices 102a-102c could access (via the web servers 106a-106b) web pages associated with a discount or other offer-related website and with an on-line forum for discussing offers. As another example, the web servers 106a-106b could provide access to web pages that present pricing information for products or services (provided by the pricing engine 112). As described in more detail below, the system 100 supports a mechanism for adding product or service offers from one website to another website. As a particular example, the system 100 could allow a user to add a coupon or other discount or an offer from an on-line vendor to a forum by automatically generating a forum post for a user.

Although FIG. 1 illustrates an example system 100 for adding product or service offers from one website to another website, various changes may be made to FIG. 1. For example, the system 100 may include any number of user devices, networks, web servers, pricing engines, database servers, and databases. Also, the functional division shown in FIG. 1 is for illustration only. Various components in FIG. 1 could be combined or omitted and additional components could be added according to particular needs. Further, the layout of the components shown in FIG. 1 is for illustration only. The components of the system 100 could be arranged in any other suitable manner, such as when the pricing engine 112 is coupled to the network 104 and is accessed by the web servers 106a-106b over the network 104. In addition, while FIG. 1 illustrates one operational environment in which the addition of offers from one website to another website can be used, this functionality could be used in any other suitable system.

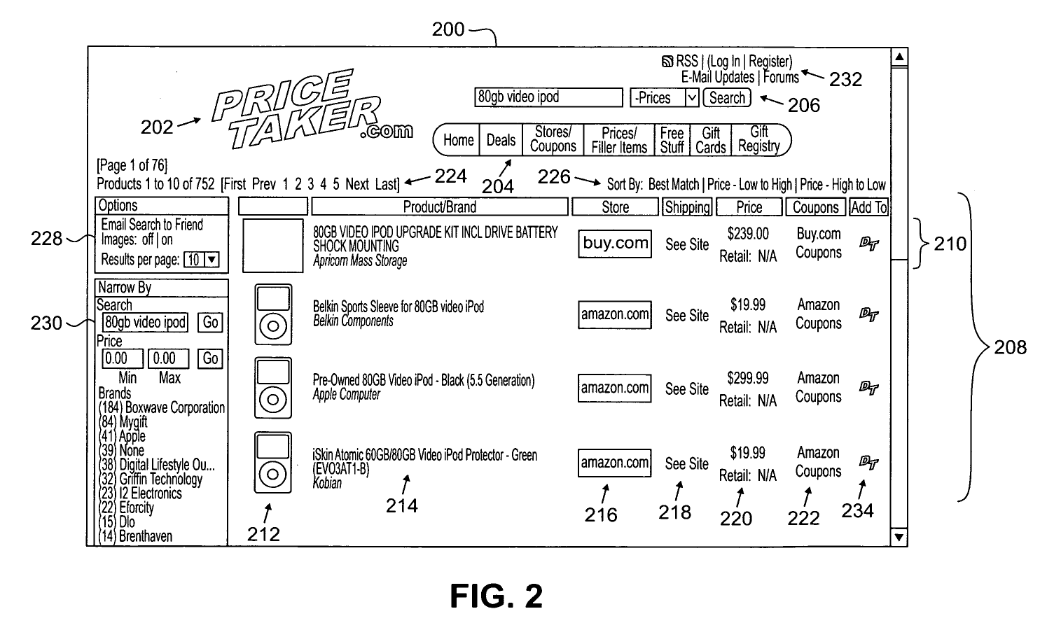

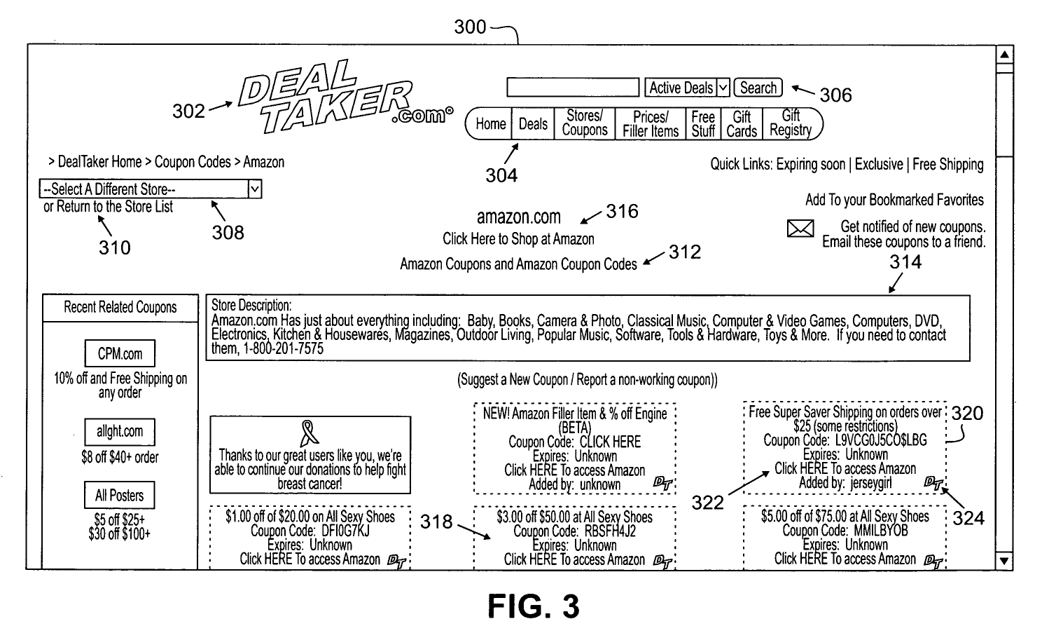

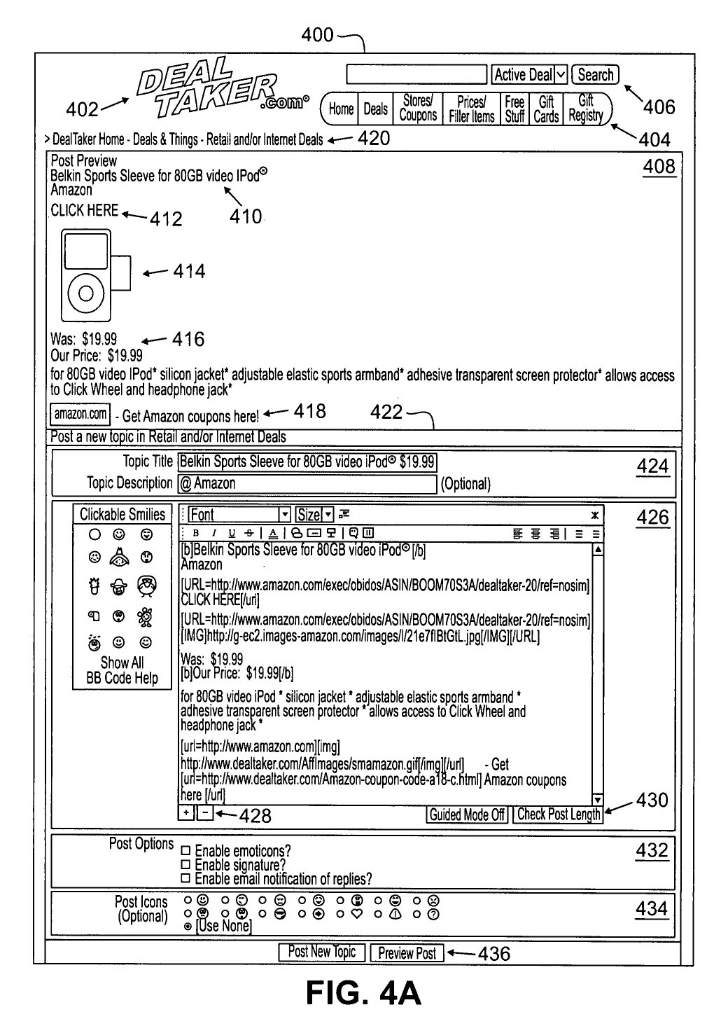

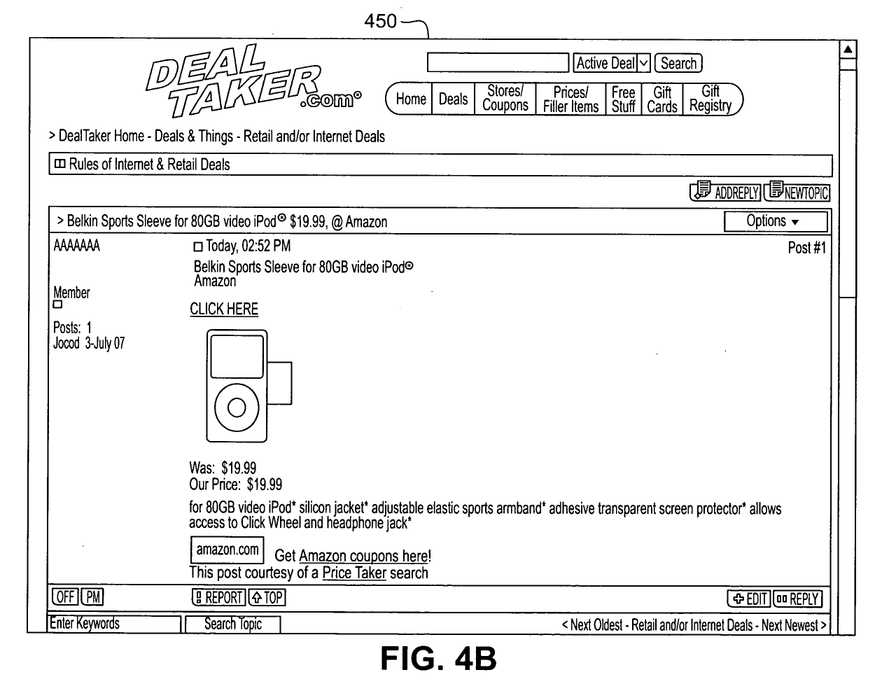

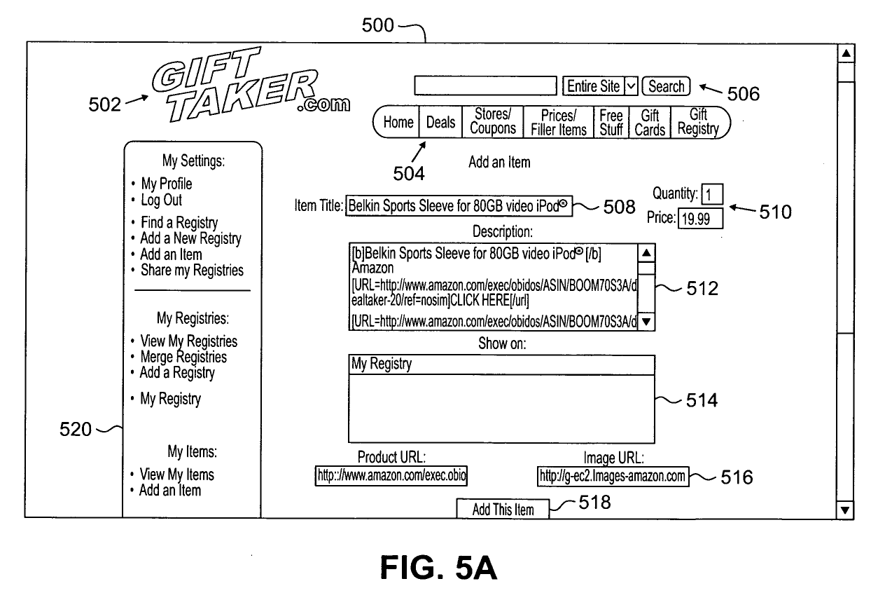

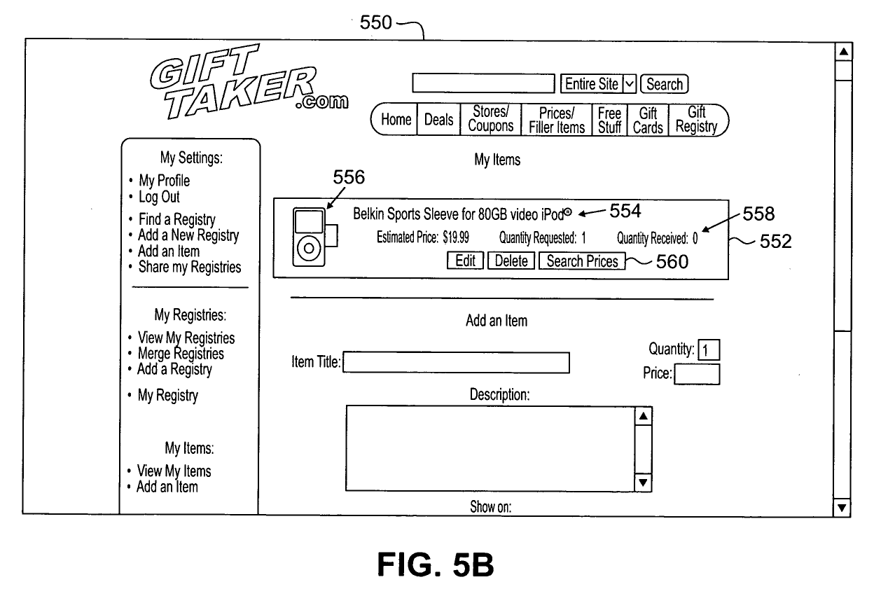

FIGS. 2 through 5B illustrate example web pages showing the addition of a product or service offer from one website to another website according to this disclosure. In particular, FIGS. 2 and 3 illustrate example web pages containing offers (pricing information and discounts, respectively) that can be inserted into web pages in FIGS. 4A-4B and 5A-5B (a forum and a gift registry, respectively). The web pages shown in FIGS. 2 through 5B are for illustration only. Other embodiments of the web pages could be used without departing from the scope of this disclosure.

As shown in FIG. 2, a web page 200 is used to present pricing information related to one or more products or services. In this example, the web page 200 includes various information and controls at the top of the web page 200. For example, the web page 200 includes a logo 202 identifying the company that owns or operates the website being accessed. The web page 200 also includes various tabs 204, which can be used to access different types of information. In this case, a “Pricing” tab 204 has been selected.

The web page 200 also supports a text search 206, which allows a user to search for prices and other charges related to one or more products or services. As an example, the user could enter text (such as a product name or product type), specify what type of search is desired (such as “prices”), and initiate the search.

In this example, pricing information associated with one or more products or services is provided in a table 208. The table 208 in this example embodiment includes various rows 210, each of which presents information associated with a single item provided by a single vendor. For example, as shown in FIG. 2, each row 210 may include an image 212 of a product or service (or a “No Image Available” image). Each row 210 may also include a description 214 of a product or service. In some embodiments, each description 214 may include or represent a hyperlink that can be selected to access a particular vendor's website to purchase the related product or service. Each row 210 may further include an icon 216 identifying the vendor offering the product or service identified in that row. In addition, each row 210 may include a shipping cost 218 for the product or service, a price 220 for the product or service, and a link 222 to any available coupons or other discounts associated with the product, service, or vendor.

The web page 200 also includes navigation links 224 that can be used by a user to navigate through the table 208. For instance, the table 208 can be divided into multiple pages (where only one page is displayed at any given time in the web page 200), and the navigation links 224 can be used to select the first, previous, next, or last page of the table 208. The web page 200 further includes sorting links 226, which can be used to sort the displayed items in various ways (such as low-to-high price, high-to-low price, or best match-to-worst match for search criteria). The user could click on various column headers of the table 208 (such as “Shipping,” “Price,” “Coupons,” or “Total”) to select the values that are sorted and to select the sorting order (ascending or descending).

In this example, the web page 200 also includes various options 228 that can be selected or set by the user. These options include the ability to email search results, control whether images are displayed in the table 208, and control the number of rows 210 displayed on the web page 200 at a given time. Other options could also be supported, such as the ability to save particular search results or view prior search results. The web page 200 further includes controls 230 for narrowing the current search results. Example ways to limit the current search results can include searching for keywords within the current search results, limiting the current search results to certain prices, and presenting the user with a list of product brands or vendors and allowing the user to select one (thereby limiting the current search results to the selected product brand or vendor).

The web page 200 also includes forum information and controls 232. As noted above, users may access and participate in on-line forums, such as a forum related to identifying and discussing discounts or other offers for products or services. In this example embodiment, the forum information and controls 232 allow the user to log into the forum or to register with the forum. The forum information and controls 232 also allow the user to sign up to receive email updates and to access particular areas of the forum. In this example, the user has not logged onto the forum. If the user had logged onto the forum, different or additional forum information and controls 232 could be presented. For instance, a particular user's login name and the number of messages awaiting the user could be shown, along with an option to log out of the forum. The forum information and controls 208 could also allow the user to access an administrator control panel (CP) and other controls for controlling the user's account and other aspects of the user's participation in the forum. The forum information and controls 208 could further allow the user to view new posts in the forum. Any other or additional forum information and controls 208 could be presented in the web page 200.

As shown here, each row 210 of the table 208 includes a button 234. The button 234 allows the user to automatically add the product or service offer associated with one row 210 of the table 208 in the web page 200 to another website. For example, selection of the button 234 could automatically create a forum post for a new thread, which the user could then add to the appropriate forum. The forum post could include information associated with the product or service related to that row 210. As another example, selection of the button 234 could automatically create a gift registry entry associated with the user. Additional details regarding this functionality are provided below.

As shown in FIG. 3, a web page 300 is used to present coupons and other discounts or offers related to one or more products or services. In this example, the web page 300 includes various information and controls at the top of the web page 300. For example, the web page 300 includes a logo 302 and tabs 304 for accessing different types of information. The web page 300 also includes various mechanisms for searching for coupons or other discounts or offers from various vendors. For instance, the web page 300 supports a text search 306, which allows a user to search for desired offers (such as discounts related to a product, manufacturer, or vendor). The web page 300 also includes a drop-down menu 308 containing a list of stores or other entities that can be selected by the user. In addition, the web page 300 includes a hyperlink 310 that can be selected in order to view a complete list of stores or other entities that can be selected by the user.

The web page 300 further contains information associated with a selected product, service, or vendor (such as a manufacturer, service provider, or store). In this example, the web page 300 contains information associated with a selected vendor. In particular, the web page 300 includes text 312 identifying the selected vendor, a description 314 of the selected vendor, and a hyperlink 316 to the selected vendor's website.

The web page 300 also includes one or more offer cells 318. Each of the offer cells 318 identifies various information associated with a coupon or other offer for a product or service provided by the selected vendor. In particular embodiments, the most popular offers could be displayed first in the offer cells 318 followed by less popular offers, although any other suitable technique could be used to determine which offer cells 318 are displayed first.

In this example embodiment, each offer cell 318 includes a boundary 320. The boundary 320 defines the overall shape and size of the offer cell 318 in the web page 300. In some embodiments, the boundary 320 also defines the area in which a particular offer can be selected, meaning the user can select anywhere within the boundary 320 (such as by using a mouse) to obtain or use the related discount or other offer. In this example, each boundary 320 is rectangular, although the offer cells 318 could have any other suitable boundary.

Within the boundary 320, each offer cell 318 includes various information 322 associated with a coupon or other offer. For example, the information 322 in an offer cell 318 could include a short description of the offer (such as an identification of a product and a price or discount associated with the product). The information 322 in the offer cell 318 may also include a coupon code that can be used at an on-line vendor's website to receive the offer associated with the cell 318. In other embodiments, the actual coupon code itself could be replaced by a hyperlink (such as a hyperlink labeled “CLICK HERE”) that redirects a user to an on-line vendor's website associated with the offered product or service. The information 322 in the offer cell 318 may further include an expiration date (if any) that identifies when the offer expires and a hyperlink that can be selected to redirect the user to an on-line vendor's website. In addition, in some embodiments, users could identify offers for products and services and add information to the database 120. In these embodiments, the information 322 in the offer cell 318 could identify a username associated with the user who created or added a particular coupon or other offer to the database.

As shown here, each offer cell 318 includes a button 324. The button 324 allows the user to automatically add the product or service offer associated with an offer cell 318 in the web page 300 to another website. For example, selection of the button 324 could automatically create a forum post for a new forum thread. The forum post could include information associated with the product or service related to that offer cell 318. As another example, selection of the button 324 could automatically create a gift registry entry associated with the user.

The automatic creation of a forum post is shown in FIGS. 4A and 4B, while the automatic creation of a gift registry entry is shown in FIG. 5A and 5B. As shown in FIGS. 4A, a web page 400 includes a formatted forum post that can be generated and used to create a new thread in an offer-tracking forum. The forum post shown in FIG. 4A could be generated automatically (such as by the web servers 106a-106b) in response to the selection of the button 234 in FIG. 2 or the button 324 in FIG. 3. As shown here, the web page 400 includes a logo 402, tabs 404, and a text search 406. The web page 400 also includes a formatted forum post 408. The contents of the formatted forum post 408 can be automatically generated or selected based on the coupon or other offer selected by the user. For example, the contents of the formatted forum post 408 could be automatically generated or selected based on the contents of the row 210 associated with the selected button 234 in FIG. 2 (or other information related to the item associated with that row 210). The contents of the formatted forum post 408 could also be automatically generated or selected based on the contents of the offer cell 318 associated with the selected button 324 in FIG. 3 (or other information related to the item associated with that offer cell 318).

In this example, the formatted forum post 408 includes a description 410 of the product or service and one or more hyperlinks 412 (such as a link to a vendor's home page and a link to the specific product or service). The formatted forum post 408 also includes an image 414 of the product or service and text 416 describing the product or service and its price. In addition, the formatted forum post 408 includes a hyperlink 418 that can be selected to view coupons or other discounts associated with the vendor (selection of this link 418 could, for example, provide the user with the web page 300 shown in FIG. 3). A destination 420 indicates the location of the new thread in the forum.

As shown in FIG. 4A, the web page 400 also includes a post definition section 422. The post definition section 422 can be used by a user to modify the automatically generated forum post 408. For example, a topic area 424 can be used to modify a title or description of the new forum post 408. The post definition section 422 also includes a post definition area 426 that can be used to modify the actual contents of the formatted forum post 408 shown in FIG. 4A. For instance, the post definition area 426 can be used to change the image, text, or hyperlinks presented in the formatted forum post 408. The post definition area 426 can also be used to select various images for display within the formatted forum post 408. Plus and minus (“+” and “−”) buttons 428 can be used to increase or decrease the size of the text block in the post definition area 426. Additional buttons 430 can be used to enable or disable guided mode (which provides prompts for creating the forum post) and to determine whether the length of the formatted forum post 408 is acceptable. Options 432 allow the user to control whether emoticons (images) and user signatures are enabled in the new forum thread and whether the user creating the forum thread is notified when replies are posted in the new forum thread. Option 434 controls whether an emoticon (image) is displayed next to the new forum thread's title in the forum. A “Preview Post” button 436 allows the user to update the formatted forum post 408, which may be useful, for example, when the user changes the contents of the post definition area 426.

A “Post New Topic” button 436 allows the user to post the formatted forum post 408 as a new thread in a forum. Selection of this button leads to the creation of an actual forum thread, which is shown in a web page 450 in FIG. 4B. As shown in FIG. 4B, the contents of the forum post in the web page 450 have been automatically generated (and possibly modified or approved by the user via web page 400). The forum post in the web page 450 can now be selected and viewed by other users, and other users can post replies to the forum post or to each other.

By using this automatic generation functionality to generate a formatted forum post, a user is able to quickly and easily create forum posts for product or service offers. Moreover, the user is able to quickly and easily modify the formatted forum post before or after the formatted forum post is actually added to the forum. This may be useful, for example, when certain users are paid a fee for each forum thread they generate related to a product or service. This functionality may help these types of users (or other users) easily create the product or service forum threads.

A similar technique could be used to add an item from the web page 200 or the web page 300 to a web page associated with a gift registry. This is illustrated in FIG. 5A, which shows a web page 500 containing a formatted gift registry entry. In this example, the web page 500 includes a logo 502, tabs 504, and a text search 506. These may be the same as or similar to corresponding elements in the web pages described above.

The web page 500 also includes a formatted gift registry entry with a title 508 and a quantity/price 510. These parameters identify the name of the item, the desired quantity, and the price of the item being placed into a gift registry. The formatted gift registry entry also includes a description section 512, which contains text describing the item being placed into the gift registry. A registry list 514 can be used by the user to select the gift registry or registries into which the entry is placed. Text boxes 516 can be used to define a hyperlink to the item on a vendor's website and a hyperlink to an image of the item. An “Add Item” button 518 can be selected by the user to add the formatted gift registry entry to the identified gift registry or registries.

Various settings 520 can be chosen and altered in FIG. 5A. For example, the settings 520 may allow the user to view his or her profile and to log into or out of the gift registry system. The settings 520 may also allow the user to locate, view, modify, share, and delete gift registries and to locate, view, and add items to the gift registries. Any other or additional settings 520 could be provided to the user.

As with the automatically generated forum post, most or all of the formatted gift registry entry (elements 508-516) in the web page 500 could be automatically selected or generated in response to the user's selection of a button 234 in FIG. 2 or a button 324 in FIG. 3. The user can then make any desired modifications and add the item to a desired registry or registries. For example, selection of the “Add Item” button 518 could lead to the creation of a gift registry entry as shown in FIG. 5B. In FIG. 5B, a web page 550 (which is similar to the web page 500 of FIG. 5A) includes a gift registry entry 552. The gift registry entry 552 could include a title 554 (which may also be used as a hyperlink that can be selected to obtain the item). The gift registry entry 552 may also include an image 556 of the item and pricing/quantity information 558 identifying the estimated price, desired quantity, and obtained quantity of the item. In addition, the gift registry entry 552 could include buttons 560 for controlling the entry 552. For instance, the “Edit” button 560 may allow the user to alter the title, description, price, quantity desired, and vendor or image hyperlinks associated with the entry 552. The “Edit” button 560 may also allow the user to assign the registry entry 552 to one or multiple gift registries. The “Delete” button 560 may allow the user to remove the entry 552 from one, some, or all gift registries. The “Search Prices” button 560 may allow a user to search for pricing information related to the item associated with the entry 552.

By using this automatic generation functionality to generate a formatted gift registry entry, a user is able to quickly and easily create entries in a gift registry for various product or service offers. Moreover, the user is able to quickly and easily modify the formatted gift registry entry before and after the entry is actually added to a gift registry.

Although FIGS. 2 through 5B illustrate examples of web pages showing the addition of a product or service offer from one website to another website, various changes may be made to FIGS. 2 through 5B. For example, each of the web pages could include any other or additional information, and each of the web pages could have any suitable arrangement and layout. Also, the ability to add product or service offers from one website to another could involve the use of any other or additional websites and is not limited to those shown in FIGS. 2 through 5B. In addition, various features of the web pages (such as text boxes and drop-down menus) are for illustration only. Any other suitable techniques could be used to collect information from a user.

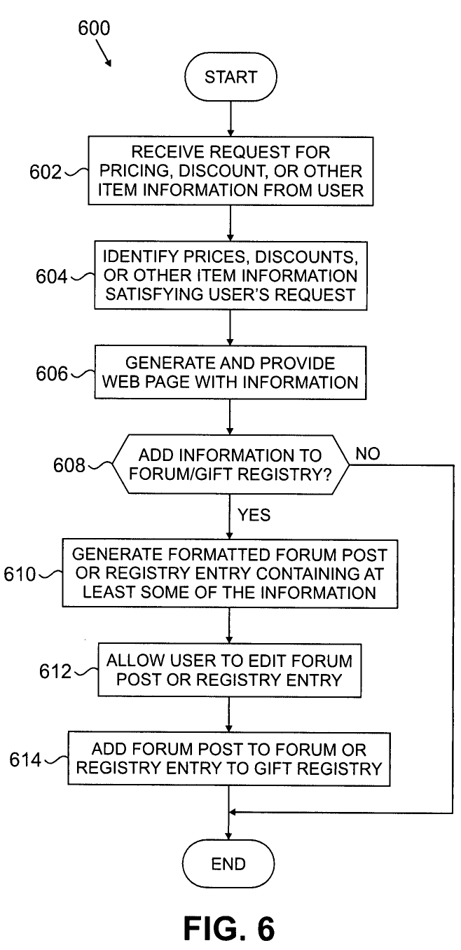

FIG. 6 illustrates an example method 600 for adding product or service offers from one website to another website according to this disclosure. In particular, the method 600 is used to add product or service offers from a pricing or other offer-related web page to a forum web page. The embodiment of the method 600 shown in FIG. 6 is for illustration only. Other embodiments of the method 600 could be used without departing from the scope of this disclosure.

A request for information associated with an item, such as pricing, discount, or other information, is received from a user at step 602. This could include, for example, a web server 106a-106b receiving a request for product or service information from a user over the network 104. As a particular example, the user may access a home page provided by the web server 106a-106b, and the user could provide search criteria or other information using the web page. The user could request information about a particular product or service, a particular type of product or service, a particular product manufacturer or service provider, or a particular store or other vendor that provides a product or service.

Information satisfying the user's request is identified at step 604. This could include, for example, the pricing engine 112 identifying pricing information for products or services that match the user's search criteria. This may also include identifying any coupons for vendors, products, or services that satisfy the user's search criteria.

A web page containing the item information is generated and provided to the user at step 606. This could include, for example, the web server 106a-106b generating a web page 200 with a table 208 of rows 210 containing item pricing information or a web page 300 containing offer cells 318 identifying one or more offers. This could also include the web server 106a-106b communicating the web page using HTML to a user device 102a-102c used by the user. This may further include the user device 102a-102c presenting the generated web page to the user.

A determination is made whether any of the item information should be added to a forum or gift registry at step 608. This could include, for example, determining if the user has selected a button 234 in the web page 200 or a button 324 in the web page 300.

If so, a formatted forum post or gift registry entry containing at least some of the relevant item information is generated at step 610. This could include, for example, the web server 106a-106b generating a web page 400 containing a formatted forum post that can be previewed by the user. This could also include the web server 106a-106b generating a web page 500 containing a formatted gift registry entry that can be previewed by the user.

If desired, the user can edit the formatted forum post or gift registry entry at step 612. For instance, the web page 400 or 500 could include text boxes, controls, and settings that can be used by the user to modify the formatted forum post or gift registry entry.

The formatted forum post or gift registry entry is added to a forum or gift registry at step 614. This could include, for example, the user selecting the “Post New Topic” button 436 in the web page 400 or the “Add This Item” button 518 in the web page 500. This may also include creating a new thread in the appropriate forum with the formatted forum post as the first post in the thread, such as is shown in the web page 450. This may further include adding a new entry 552 in the appropriate gift registry, such as is shown in the web page 550.

Although FIG. 6 illustrates one example of a method 600 for adding product or service offers from one website to another website, various changes may be made to FIG. 6. For example, the same or similar technique could be used to add an item to any other web page. Also, while shown as a series of steps, various steps in FIG. 6 could overlap, occur in parallel, or occur multiple times.

In some embodiments, various functions described above can be implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory.

It may be advantageous to set forth definitions of certain words and phrases that have been used within this patent document. The term “couple” and its derivatives refer to any direct or indirect communication between two or more components, whether or not those components are in physical contact with one another. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

While this disclosure has described certain embodiments and generally associated methods, alterations and permutations of these embodiments and methods will be apparent to those skilled in the art. Accordingly, the above description of example embodiments does not define or constrain this invention. Other changes, substitutions, and alterations are also possible without departing from the spirit and scope of this invention as defined by the following claims.

What is claimed is:

1. A method comprising:
generating a web page comprising information associated with one or more offers for one or more items;
providing the web page for presentation to a first user;
receiving a selection of one of the offers;
generating a forum post, wherein at least a portion of contents of the forum post is automatically selected or generated based on the selected offer; and
creating a thread in a forum using the forum post, the thread accessible by one or more second users.

2. The method of claim 1, further comprising:
generating a second web page comprising the forum post; and
providing the second web page for presentation to the one or more second users.

3. The method of claim 1, wherein:
the web page comprises pricing information associated with the one or more items; and
receiving the selection of one of the offers comprises receiving a selection associated with the pricing information for one of the items.

4. The method of claim 1, wherein:
the web page comprises discounts associated with the one or more items; and
receiving the selection of one of the offers comprises receiving a selection associated with the discount for one of the items.

5. The method of claim 1, further comprising:
presenting the forum post to the first user; and
allowing the first user to modify the forum post prior to creating the thread in the forum.

6. The method of claim 1, wherein generating the forum post comprises generating a forum post having an image, a description, and a hyperlink associated with one of the items.

7. An apparatus comprising:
at least one memory configured to store information associated with one or more offers for one or more items; and
at least one processor configured to:
generate a web page comprising at least some of the information associated with the one or more offers;
provide the web page for presentation to a first user;
receive a selection of one of the offers;
generate a forum post, wherein at least a portion of contents of the forum post is automatically selected or generated based on the selected offer; and
create a thread in a forum using the forum post, the thread accessible by one or more second users.

8. The apparatus of claim 7, wherein the at least one processor is further configured to:
generate a second web page comprising the forum post; and
provide the second web page for presentation to the one or more second users.

9. The apparatus of claim 7, wherein:
the web page comprises pricing information associated with the one or more items; and
the selection of one of the offers comprises a selection associated with the pricing information for one of the items.

10. The apparatus of claim 7, wherein:
the web page comprises discounts associated with the one or more items; and
the selection of one of the offers comprises a selection associated with the discount for one of the items.

11. The apparatus of claim 7, wherein the at least one processor is further configured to:
present the forum post to the first user; and
allow the first user to modify the forum post prior to creating the thread in the forum.

12. The apparatus of claim 7, wherein the at least one processor is configured to generate the forum post by generating a forum post having an image, a description, and a hyperlink associated with one of the items.

13. A computer program embodied on a computer readable medium, the computer program includes computer readable program code for:
generating a web page comprising information associated with one or more offers for one or more items;
providing the web page for presentation to a first user;
receiving a selection of one of the offers;
generating a forum post, wherein at least a portion of contents of the forum post is automatically selected or generated based on the selected offer; and
creating a thread in a forum using the forum post, the thread accessible by one or more second users.

14. A method comprising:
generating a web page comprising information associated with one or more offers for one or more items;
providing the web page for presentation to a first user;
receiving a selection of one of the offers;
generating a gift registry entry, wherein at least a portion of contents of the gift registry entry is automatically selected or generated based on the selected offer; and
adding the gift registry entry to at least one gift registry, the gift registry entry accessible by one or more second users.

15. The method of claim 14, further comprising:
generating a second web page comprising the gift registry entry; and
providing the second web page for presentation to the one or more second users.

16. The method of claim 14, wherein:
the web page comprises pricing information associated with the one or more items; and
receiving the selection of one of the offers comprises receiving a selection associated with the pricing information for one of the items.

17. The method of claim 14, wherein:
the web page comprises discounts associated with the one or more items; and
receiving the selection of one of the offers comprises receiving a selection associated with the discount for one of the items.

18. The method of claim 14, wherein generating the gift registry entry comprises automatically selecting or generating a title, a quantity, a price, a description, and a hyperlink based on the selected offer.

19. The method of claim 18, further comprising allowing the first user to modify at least one of the title, the quantity, the price, the description, and the hyperlink prior to adding the gift registry entry to the at least one gift registry.

20. An apparatus comprising:
at least one memory configured to store information associated with one or more offers for one or more items; and
at least one processor configured to:
generate a web page comprising at least some of the information associated with the one or more offers;
provide the web page for presentation to a first user;
receive a selection of one of the offers;
generate a gift registry entry, wherein at least a portion of contents of the gift registry entry is automatically selected or generated based on the selected offer; and
add the gift registry entry to at least one gift registry, the gift registry entry accessible by one or more second users.

21. The apparatus of claim 20, wherein the at least one processor is further configured to:
generate a second web page comprising the gift registry entry; and
provide the second web page for presentation to the one or more second users.

22. The apparatus of claim 20, wherein:
the web page comprises pricing information associated with the one or more items; and
the selection of one of the offers comprises a selection associated with the pricing information for one of the items.

23. The apparatus of claim 20, wherein:
the web page comprises discounts associated with the one or more items; and
the selection of one of the offers comprises a selection associated with the discount for one of the items.

24. The apparatus of claim 20, wherein the at least one processor is configured to generate the gift registry entry by automatically selecting or generating a title, a quantity, a price, a description, and a hyperlink based on the selected offer.

25. The apparatus of claim 24, wherein the at least one processor is further configured to allow the first user to modify at least one of the title, the quantity, the price, the description, and the hyperlink prior to adding the gift registry entry to the at least one gift registry.

26. A computer program embodied on a computer readable medium, the computer program includes computer readable program code for:
generating a web page comprising information associated with one or more offers for one or more items;
providing the web page for presentation to a first user;
receiving a selection of one of the offers;
generating a gift registry entry, wherein at least a portion of contents of the gift registry entry is automatically selected or generated based on the selected offer; and
adding the gift registry entry to at least one gift registry, the gift registry entry accessible by one or more second users.

27. A method comprising:
receiving a web page comprising information associated with one or more offers for one or more items;
presenting the web page to a first user;
communicating a selection of one of the offers;
receiving a forum post, wherein at least a portion of contents of the forum post is automatically selected or generated based on the selected offer; and
initiating creation of a thread containing the forum post in a forum, the thread accessible by one or more second users.

28. A method comprising:
receiving a web page comprising information associated with one or more offers for one or more items;
presenting the web page to a first user;
communicating a selection of one of the offers;
receiving a gift registry entry, wherein at least a portion of contents of the gift registry entry is automatically selected or generated based on the selected offer; and
initiating addition of the gift registry entry to at least one gift registry, the gift registry entry accessible by one or more second users.
